(19) United States
(12) Patent Application Publication
(10) Pub. No.: US 2015/0285575 A1
(43) Pub. Date: Oct. 8, 2015

(54) Firearm Silencer with a Replacement Core

(71) Applicant: Michael L. Sclafani, Conroe, TX (US)

(72) Inventor: Michael L. Sclafani, Conroe, TX (US)

(21) Appl. No.: 14/726,072

(22) Filed: May 29, 2015

(51) Int. Cl. F41A 21/30

(52) U.S. Cl. CPC F41A 21/30; B33Y 10/00

(57) ABSTRACT

A silencer for a firearm includes a one piece, solid body diffuser core formed by a three dimensional printing process. The core is positioned within a tubular housing which may be formed of metal. A pair of end caps maintain the core member within the housing. After prolonged use, the core member may be removed and replaced by removing one of the end caps.

### BACKGROUND OF THE INVENTION

1. Field of the Invention

This application relates to a silencer for firearms for example a rifle. The silencer is typically attached to the end of the barrel of a rifle and serves to attenuate the noise level associated with the firing of a round in the rifle.

### BACKGROUND OF THE INVENTION

Known silencers typically consist of an outer housing that is connectable to the end of the rifle barrel by screw threads.

The interior of the housing supports a plurality of individual cone-shaped baffle members and supporting structure. The cone members are individually machined and must be secured within the housing. These baffles are typically formed of metal and are subjected to wear and corrosion caused by the explosive gases entering the housing.

After a limited number of rounds, the cone baffles fail and the entire silencer must be replaced. Each silencer is subject to an additional federal tax which increases the cost of replacement.

Consequently, there is a need for a silencer that is less costly to manufacture and that can be reused without incurring an additional tax.

### BRIEF SUMMARY OF SOME OF THE PREFERRED EMBODIMENTS

These and other needs in the art are addressed in one embodiment by forming the internal baffle as a monolithic, one piece, homogeneous core structure, using longer lasting materials such as plastics. The core member can be formed by using a three dimensional printer unit that will create a solid, one piece structure formed of a high strength plastic or metallic material.

When it is necessary to replace the core member after prolonged use, the core may be removed from the outer housing and simply replaced by a new core member.

### BRIEF DESCRIPTION OF THE DRAWINGS

FIG. 1 illustrates a cross sectional view of the housing without the core member.

FIG. 2 illustrates a cross sectional view of the core member.

FIG. 3 represents a cross sectional view of the entire silencer assembly.

### DETAILED DESCRIPTION OF A PREFERRED EMBODIMENT

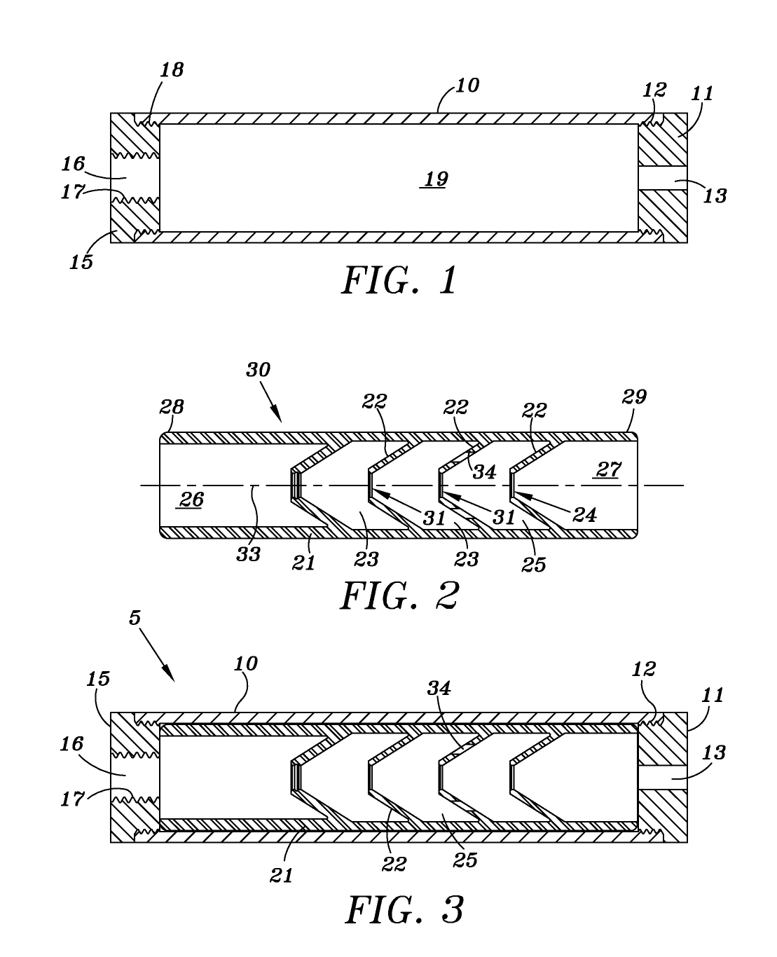

Referring now to FIGS. 1-3, a preferred embodiment of the invention will now be described. As shown in FIG. 3, the complete silencer assembly includes an outer tubular housing 10 having an internal cavity 19. At one end of the housing 10 a first end cap member 15 is connected to housing 10 via threads 18. Cap member 15 includes an opening 16 having threads 17 which allows the silencer assembly to be attached to the outer end of a firearm barrel which has complimentary threads on its outer surface.

A second end cap member 11 is connected to housing 10 via threads 12. Second cap member 11 includes a bore 13 through which the bullet fired by the firearm exits the silencer.

FIG. 2 illustrates the structure of the core member 30. Core member may be formed by a three dimensional printer such that the core member consist of a one piece, monolithic and homogeneous body. The core member includes a tubular annular housing 21 having an inlet cavity 26 and an outlet cavity 27. A plurality of cone shaped baffles 22 are formed within the internal cavity of the tubular housing 21 and diverge toward outlet cavity 27. Baffles 22 form openings 24 which allows a bullet to pass through the core member 30. A plurality of annular air chambers 25 are located between the core baffles 22. Openings 34 may be provided in baffles 22.

When it is desired to replace the core member after prolonged use, cap 11 or 15 can be removed and core member 30 withdrawn from tubular housing 10. A new core member may then be placed within the tubular housing 10 and the cap member can be rethreaded into the tubular housing.

The core member 2 can be fabricated by any available three dimensional printer. Materials which may be used with the printer for example include plastic material, a composite material such as carbon fiber, or metallic material. A suitable plastic material is acrylonitrile butadiene styrene commonly called, ABS Plastic.

Although the present invention and its advantages have been described in detail, it should be understood that various changes, substitutions and alterations may be herein without departing from the spirit and scope of the invention as defined by the appended claims.

What is claimed is:

1. A silencer for a firearm comprising:
a. a tubular housing having an interior cavity,
b. at least one end cap member closing an end of the tubular housing,
c. a monolithic, one piece core member having an internal cavity and a plurality of baffles positioned within the cavity; said core member positioned within the tubular housing.

2. A silencer as claimed in claim 1 including a plurality of air chambers positioned between the baffles.

3. A silencer as claimed in claim 1 wherein the baffles are cone-shaped and include a central aperture having a center point aligned with a longitudinal axis of the tubular housing.

4. A silencer as claimed in claim 1 wherein the core member is fabricated by a three dimensional printer.

5. A silencer as claimed in claim 1 wherein the core member is made of plastic.

6. A silencer as claim in claim 5 wherein the plastic is ABS plastic.

7. A method of restoring a worn silencer having a tubular housing, an end cap, and a core member including a plurality of baffles comprising;
a. removing the end cap from the tubular housing,
b. removing the core member from the housing,
c. inserting a one piece, monolithic core member including a plurality of baffles into the tubular housing, the core member being fabricated by a three dimensional printer, and
d. reattaching the end cap to the tubular housing.
